(19) United States
(12) Patent Application Publication
(10) Pub. No.: US 2023/0127661 A1
(43) Pub. Date: Apr. 27, 2023

(54) APPARATUS FOR THE OPTICAL MANIPULATION OF A PAIR OF LANDSCAPE STEREOSCOPIC IMAGES

(71) Applicant: John Alexander Christian, Wimborne (GB)

(72) Inventor: John Alexander Christian, Wimborne (GB)

(21) Appl. No.: 17/911,699

(22) PCT Filed: Mar. 10, 2021
(86) PCT No.: PCT/GB2021/000024

§ 371 Date: Sep. 15, 2022

(30) Foreign Application Priority Data
Mar. 20, 2020 (GB) 2004164.6
Oct. 23, 2020 (GB) 2016921.5

(51) Int. Cl. G03B 35/10; G02B 30/35; G03B 13/34; G02B 23/24; G02B 23/08

(52) U.S. Cl. CPC G03B 35/10; G02B 30/35; G03B 13/34; G02B 23/2446; G02B 23/08; G02B 23/2415; A61B 1/00193

(57) ABSTRACT

Apparatus (38) for the optical manipulation of a pair of landscape stereoscopic images (L, R), which apparatus (38) comprises: (i) a camera (36) which has its own focus lens (40); (ii) an enclosed housing (4), three ports (6, 8, 10) in the housing (4) with one port being a photographic interface port which forms a photographic interface (12) to the camera (36), and the other two ports being human interface ports which form a human interface (18), said three ports (6, 8, 10) allowing the light to pass from the human interface to the photographic interface (12) for camera recording, or from the photographic interface (12) to the human interface (18) for each eye of the human, in a direction parallel to that of light entering the other said interface without left-right image inversion between the photographic interface (12) and the human interface (18); and (iii) at least four reflective surfaces (20, 22, 24,26) which direct light along three mutually perpendicular axes, each of said surfaces having an edge lying on a flat plane (28), said plane (28) also including a division line (30) between adjacent landscape stereoscopic images presented at said photographic interface (12), whereby the apparatus (38) causes landscape stereoscopic images which are side by side with a left eye image left of a right eye image and with shortest dimensions adjacent and which are at the human interface (18) to become stacked one image above the other at the photographic interface (12), and wherein: (iv) the apparatus (38) causes the left and right eye images which are stacked one image above the other at the photographic interface (12) to emerge as parallel light towards the camera (36); and (v) the focus lens of the camera (36) is on an optical axis passing through the centre of the photographic interface port and is focussed for infinity distance to receive the parallel light conveying the two stereoscopic images.

This invention relates to optical apparatus and, more especially, this invention relates to apparatus for the optical manipulation of a pair of landscape stereoscopic images.

Normal human eyesight is stereoscopic. This means that the human brain is able to judge the distance to an object by comparing differences between the images captured by each eye from different positions. Eye separation is typically 63 mm but the ability to interpret relative distances is still maintained when this image capture separation distance is artificially increased, for example as with binoculars, or is artificially reduced for example as with a microscope or an endoscope.

Stereoscopic images have been captured historically by the use of two cameras and complex means for directing the resulting images separately to each eye. In some cases, separate but linked projectors have been used together with polarising spectacles in order to segregate the images superimposed on a screen. A variation on this, usually employed for video purposes, is to show left and right images alternatively to the same camera. The images alternate in time and/or as strips across a screen, either horizontally or vertically. All of these known systems have an adverse effect on image quality, unless additional complications are included by way of memory to fill the gaps for each of the stereoscopic images. Such additional complications require dedicated and complicated electronics, which must also direct the assembled components of each image to the appropriate human eye.

In EP 1262074 B1, there is disclosed improved apparatus for the optical manipulation of a pair of landscape stereoscopic images. The apparatus comprises an enclosed housing, three ports in the housing with one port forming a photographic interface and the other two ports forming a human interface. The ports allow the light to pass from the human interface to the photographic interface for camera recording, or from the photographic interface to the human interface for each eye of the human, in a direction parallel to that of light entering the other said interface without left-right image inversion between the photographic interface and the human interface. The apparatus has at least four reflective surfaces which direct light along three mutually perpendicular axes, each of said surfaces having an edge lying on a flat common plane. The plane also includes the division line between adjacent landscape stereoscopic images presented at said photographic interface. The apparatus causes landscape stereoscopic images which are side by side with a left eye image left of a right eye image and with shortest dimensions adjacent and which are at the human interface to become stacked one image above the other at the photographic interface.

With known optical apparatus giving monoscopic images, and also with the optical apparatus of EP 1262074 B1 which gives stereoscopic images, a difficulty may arise when camera technology provides potentially improved performance for the apparatus, but does not necessarily have the same format size as the dedicated camera. The lack of the same format size prevents the use of the improved performance for the apparatus.

It is an aim of the present invention to reduce or avoid the above mentioned problem.

Accordingly, in one non-limiting embodiment of the present invention there is provided apparatus for the optical manipulation of a pair of landscape stereoscopic images, which apparatus comprises:
(i) a camera which has its own focus lens;
(ii) an enclosed housing, three ports in the housing with one port being a photographic interface port which forms a photographic interface to the camera, and the other two ports being human interface ports which form a human interface, said three ports allowing the light to pass from the human interface to the photographic interface for camera recording, or from the photographic interface to the human interface for each eye of the human, in a direction parallel to that of light entering the other said interface without left—right image inversion between the photographic interface and the human interface; and
(iii) at least four reflective surfaces which direct light along three mutually perpendicular axes, each of said surfaces having an edge lying on a flat plane, said plane also including a division line between adjacent landscape stereoscopic images presented at said photographic interface, whereby the apparatus causes landscape stereoscopic images which are side by side with a left eye image left of a right eye image and with shortest dimensions adjacent and which are at the human interface to become stacked one image above the other at the photographic interface,
   and wherein:
(iv) the apparatus causes the left and right eye images which are stacked one image above the other at the photographic interface to emerge as parallel light towards the camera; and
(v) the focus lens of the camera is on an optical axis passing through the centre of the photographic interface port and is focussed for infinity distance to receive the parallel light conveying the two stereoscopic images.

The apparatus of the present invention is different from the apparatus disclosed in EP 1262074 B1 in that with the apparatus of the present invention, the apparatus is configured such that the left and right eye images which are stacked one image above the other at the photographic interface are caused to emerge as parallel light towards the camera. In EP 1262074 B1, the apparatus uses a focus lens arrangement in the train of lenses for each image. This focus lens focusses the image onto the back of the dedicated camera. By removing the focus lens arrangement in the train of lenses for each image, the stacked images are then able to operate as parallel light. The camera is then able to be provided with a focus lens which is focussed for infinity and is thus able to receive the parallel light. This has the advantage that improved performance is able to manifest itself in improved image quality which is able to be received by the better quality camera.

The apparatus of the present invention may comprise a first optical path for conveying a first one of the landscape stereoscopic images, and a second optical path for conveying a second one of the landscape stereoscopic images.

The apparatus may include distance-adjusting means for adjusting the distance between the photographic interface port and the focus lens of the camera. The apparatus may be one in which the focus lens of the camera has a focal length for the particular camera format size such that variation of the distance apart of the camera and photographic interface port changes the size of the focussed images until they map onto a full light-sensitive area of the camera.

The distance-adjusting means may enable the image size to be matched to that of a chip in the camera by adjusting the distance between the photographic interface port and the focus lens of the camera. Preferably, the distance-adjusting means is such that the output is on an optical axis with the camera focussed for infinity by a positive lens which has an appropriate focal length for the particular camera format size, such that variation of the distance between the photographic interface port and the focus lens of the camera changes the size of the focussed images until they map onto the full light-sensitive area of the camera. Alternatively, if desired, instead of using a distance-adjusting means, a zoom lens on the camera may be employed to have a similar effect. The zoom lens on the camera may however require the camera to be of an increased size as compared with the camera not having the zoom lens.

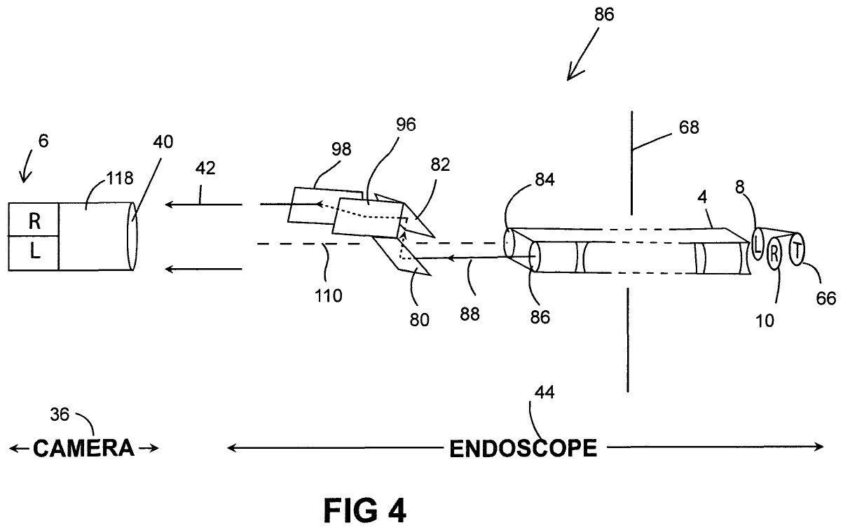

The apparatus of the present invention may be one in which a pair of positive and negative lenses located before and after a periscope pair of reflective surfaces share a focal point such that they inversely magnify an image such that the width of view becomes wider and the depth of focus becomes greater. In FIG. 4 of EP 1262074 B1, two periscopes are disclosed which operate in series. In the apparatus of the present invention, using the two periscopes separately such that there is one periscope in each image train, has the advantages of firstly providing the inverse magnification and secondly of providing better matching the light paths for the two images, regarding both light losses and path length between interacting lenses.

The apparatus of the present invention may be one in which there is a right eye light path from a target through serial pairs of relay lenses to a vertical periscope having a pair of reflective surfaces acting vertically and through a positive lens which shares a focus with a negative lens such that the light emerges from the positive lens parallel towards the camera, and in which the apparatus includes a similar light path for the left eye image such that the light paths are initially side by side but the left eye light passes through a horizontal periscope having reflective surfaces configured such that parallel light for the left eye image emerges through a positive lens below that for the right eye. The apparatus may be one in which the reflective surfaces of each periscope are positioned such that the angle between incident and reflected light is acute to increase the length of the light path or obtuse to reduce the length of the light path, and such that the light path distance for the two images is made equal.

The apparatus of the present invention may be one in which there are two periscopes which act serially within the same optical path, such that images captured from side by side lenses become repositioned one above the other for the photographic interface.

The apparatus of the present invention may be one in which the light paths for the left eye and right eye are interchangeable through 180° rotation of the apparatus about the optical axis of the focus lens of the camera, such that the horizontal periscope is able to act for either left or right eye image. The apparatus may be one in which a reflective surface of the horizontal periscope is rotatable about a vertical axis such that the left and right eye views recorded by the camera are parallel or converge to cross over at a finite distance from the camera.

The apparatus of the present invention may be one in which a reflective surface of the vertical periscope is able to be rotated about the edge which lies in the flat plane, thereby enabling precise vertical alignment of the two images such that top and bottom borders correspond.

The apparatus of the present invention may be one in which a reflective surface of the horizontal periscope is rotatable about the edge lying in the flat plane, such that one stereoscopic image may be rotated with respect to its counterpart until vertical features in one image are parallel with corresponding features of the other image.

The apparatus of the present invention may comprise a pair of lenses acting at the ends of the periscope in each image channel to provide inverse magnification. In this embodiment of the invention, a negative lens at the proximal end of the relay lenses may share a common focal point with a positive lens located at the photographic interface of the four reflective surfaces. The apparatus may be one in which there is a right eye light path from a target through series pairs of relay lenses, including to a single periscope pair of reflective surfaces, and through a positive lens which shares a focus with a negative lens, such that parallel light emerges from the positive lens towards the camera. The apparatus may then include a similar light path for the left eye image such that the light paths are initially side by side but left eye light passes through a horizontal periscope formed by reflective surfaces such that parallel light for the left eye image emerges through a positive lens below that for the right eye.

The apparatus of the present invention may employ two periscopes which are configured such that one of the periscopes acts across the width of an image whilst the other periscope acts across the length of the other image, and thereby obtain a difference in path length when addressing focus. In this embodiment of the invention, the apparatus may include rotation means for rotating periscope pairs of reflective surfaces in the plane of the light which enters and leaves each periscope, such that the light path between lenses in the input and output may be varied in length. Any unwanted difference can be corrected by slightly shortening or lengthening the total path length by rotation of the two parallel reflective surfaces in the plane which contains the input and output light of the periscope formed by either pair of reflective surfaces. If the angle between incident and reflective path for one reflection is obtuse, then the path length becomes shorter. Conversely, an acute angle causes a longer path length.

The apparatus of the present invention is able to find application is a wide variety of fields including medical fields, industrial fields and media fields. In the medical and industrial fields, the apparatus may be produced in the form of an endoscope. In the media and industrial fields, the apparatus may be produced in the form of a camera attachment for live or recorded stereoscopic video, for example targeted at remotely located observers, where the separation of the left eye and right eye lenses is comparable to human eye separation.

Embodiments of the invention will now be described solely by way of example and with reference to the accompanying drawings in which:

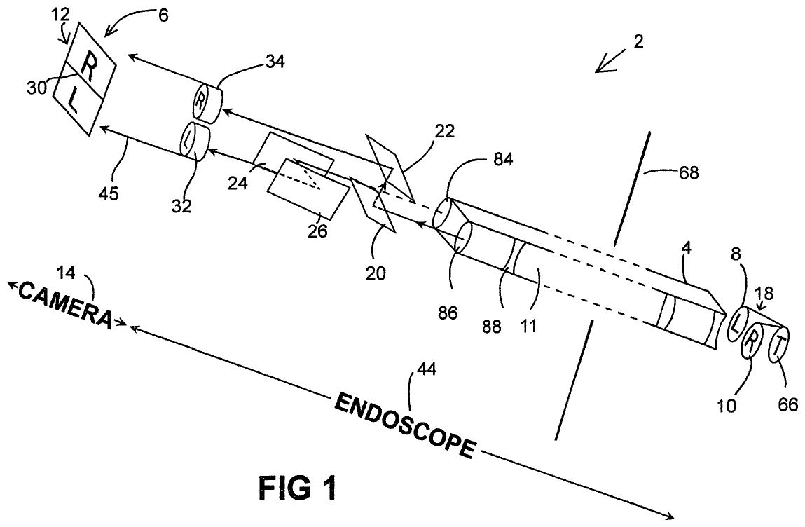

FIG. 1 shows known apparatus of the type disclosed in EP 1262074 B1, with FIG. 1 showing only one periscope in the light path for each image, whereas EP 1262074 B1 shows two periscopes acting serially on the same image;

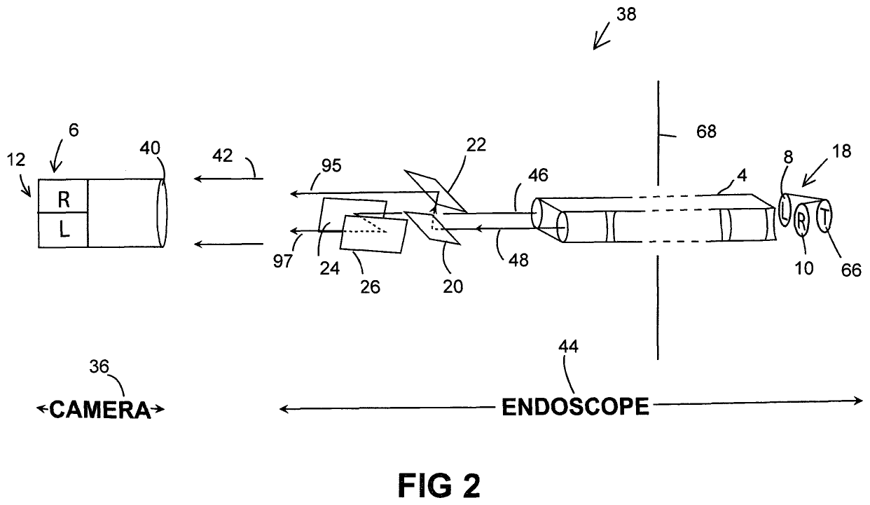

FIG. 2 shows first apparatus of the present invention;

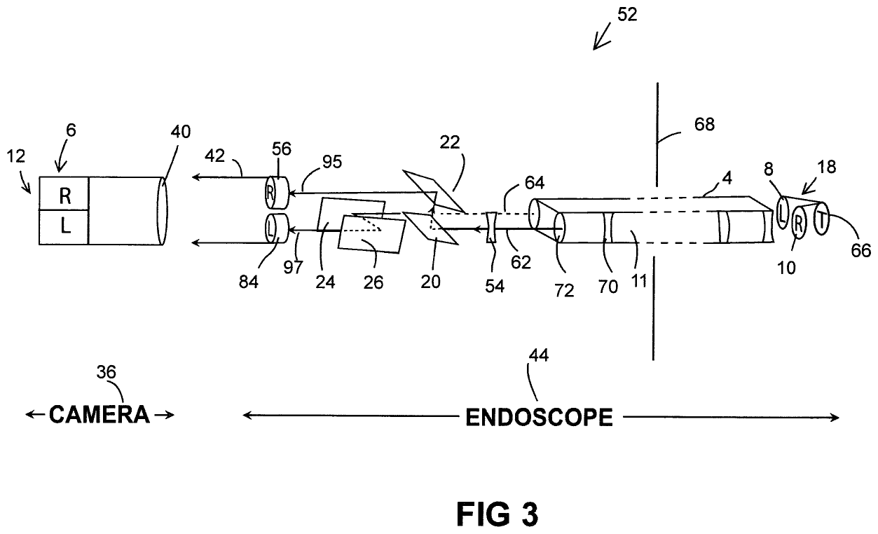

FIG. 3 shows second apparatus of the present invention;

FIG. 4 shows third apparatus of the present invention;

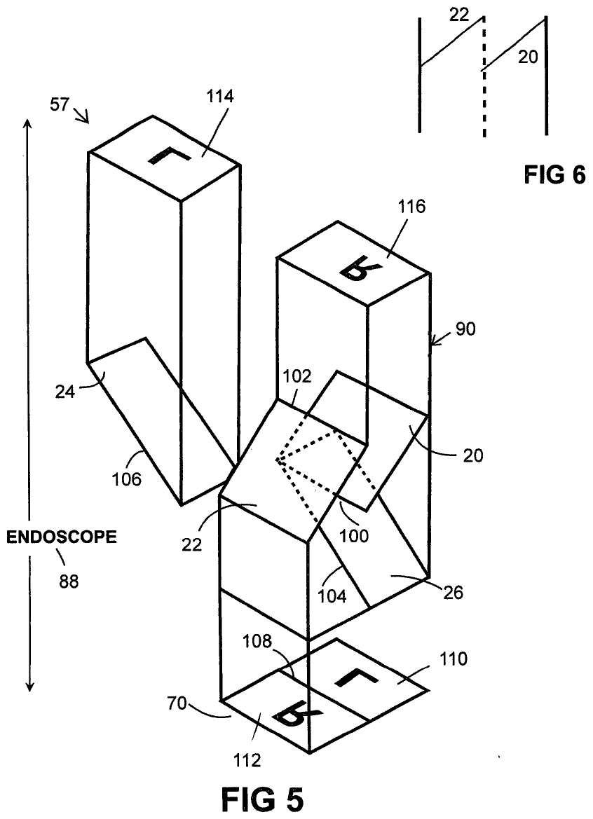

FIG. 5 shows a periscope arrangement for use in the apparatus of the present invention;

FIG. 6 is a side view of part of the periscope apparatus shown in FIG. 5; and

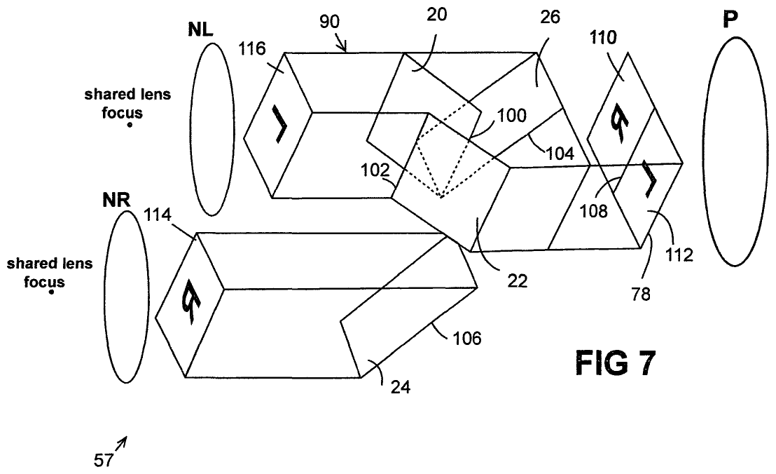

FIG. 7 shows how the invention may be used for normal eye separation of the ports at the human interface, and in which reflective surfaces are preferably front surface mirrors.

Referring to FIG. 1, there is shown apparatus 2 for the optical manipulation of a pair of landscape stereoscopic images L, R. The apparatus 2 comprises an enclosed housing 4. The housing 4 comprises a metal tube through which required optical paths are contained. The housing 4 may contain relay lenses for both images.

The apparatus 2 also comprises three ports 6, 8, 10 which are in the housing 4. One of these ports forms a photographic interface 12 to a camera 14. The other two of these ports form a human interface 18.

The ports 6, 8, 10 allow light to pass from the human interface 18 to the photographic interface 12 for camera recording, or from the photographic interface 12 to the human interface 18 for each eye of the human, in a direction parallel to that of light entering the other said interface without left-right imaging inversion between the photographic interface and the human interface.

The apparatus 2 comprises at least four reflective surfaces 20, 22, 24, 26 which direct light along three mutually perpendicular axes. As can be appreciated from FIG. 5 and FIG. 6, each of said reflective surfaces 20, 22, 24, 26 has an edge lying on a flat common plane 28. The flat common plane 28 includes the division line 30 in FIG. 1 and 108 in FIG. 5 between adjacent landscape stereoscopic images presented at the photographic interface 12. The apparatus 2 causes landscape stereoscopic images L, R which are side by side with a left eye image left of a right eye image and with shortest dimensions adjacent and which are at the human interface 18, to become stacked one image upon the other at the photographic interface 12.

The apparatus 2 shown in FIG. 1 is such that it includes focus lenses 32, 34 for the camera 14. The two focus lenses 32, 34 are used one each for each image train for image L and image R for focussing the images L, R onto the back of the camera 14. The two focus lenses 32, 34 may optionally be in the form of a single large diameter positive lens.

The camera 14 is a dedicated camera for the remainder of the apparatus 2. More specifically, an endoscope 44 focusses light 45 onto the back of the dedicated camera 14. A problem can occur when camera technology provides improved performance for the endoscope 44 but not for the camera 14. The camera technology may not necessarily have the same format size as the camera 14. Because the camera 14 is a dedicated camera, the improved performance for the endoscope 44 is not able to be obtained.

Referring now to FIG. 2, there is shown apparatus 38 of the present invention. Similar parts as in the apparatus 2 have been given the same reference numerals for ease of comparison and understanding.

The apparatus 38 comprises a camera 36 and an endoscope 44. The apparatus 38 is configured such that the endoscope 44 causes the left and right eye images L, R which are stacked one image above the other at the photographic interface 12 to emerge as parallel light 42 towards the camera 36. This is effected by removing the focus lenses 32, 34 in the apparatus 2. In the apparatus 38, the camera 36 is provided with a focus lens 40 which is focussed for infinity distance to receive the parallel light 42 from the endoscope 44. The camera 36 is fitted on the optical axis of the endoscope 44 such that the parallel light 42 from the endoscope 44 is received by the focus lens 40 and thus the images are always in sharp focus as received by the camera 36. A surgeon using the apparatus 38 as compared with the apparatus 2 is thus able to receive improved images in terms of clarity. The surgeon may thus be able to work with better precision and/or less eye fatigue. The apparatus 38 includes a first optical path 46 for conveying a first one of the landscape stereoscopic images L, R and a second optical path 48 for conveying a second one of the landscape stereoscopic images L, R.

In the apparatus 38 shown in FIG. 2, the parallel light output 42 from the endoscope 44 is aligned for the camera 36. The camera 36 is focussed for infinity by a positive lens 40 which has an appropriate focal length for the particular camera format size. Variation of the separation distance between the camera 36 and the endoscope 44 changes the size of the focussed images until the focussed images map onto the full light-sensitive area of the camera 36.

In the apparatus 38 shown in FIG. 2, the reflective surfaces 20, 22 form part of a periscope acting on the right eye image R. The reflective surfaces 24, 26 form part of a horizontally acting periscope for the left eye image 6.

FIG. 3 shows apparatus 52. Similar parts as in the apparatus 38 have been given the same reference numerals for ease of comparison and understanding. In FIG. 3, it will be seen that the apparatus 52 includes a pair of negative and positive lenses 54, 56 before and after a periscope pair of reflective surfaces 20, 22. The pair of positive and negative lenses 54, 56 located before and after the periscope pair of reflective surfaces 20, 22 share a focal point 62 such that they inversely magnify an image.

FIG. 3 illustrates the endoscope 54 being such that there is a right eye light path 62 from a target 66 inside a human body 68 through serial pairs of endoscope relay lenses 70, 72 to a single periscope pair of reflective surfaces 20, 22 acting vertically as shown in FIG. 3. The right eye light path 62 passes through a positive lens 56 such that light emerges from the positive lens 56 as the parallel light 42 and is directed towards the camera 36. The apparatus 52 includes a similar light path for the left eye image L such that the light paths are initially side by side, but the left eye light passes through a horizontal periscope formed by reflective surfaces 24, 26 such that parallel light for the left eye image L emerges through positive lens 84 below that for the right eye.

As shown in FIG. 3, the lenses 70, 72 share a common focus 11. The lenses 54, 56 share a common focus which is not shown in FIG. 3. The lenses 70, 72 and 54, 56 enable required magnification.

The apparatus 52 may be such that it includes rotation means for rotating periscope pairs of reflective surfaces 20, 22; 24, 26 in the plane of the light which enters and leaves each periscope such that the light path between the lenses on the input and output is varied in length.

Referring now to FIG. 4, the apparatus of the present invention may be one in which both periscopes are axially within the same optical path, such that images captured from side by side lenses become repositioned one above the other for the photographic interface.

FIG. 4 shows apparatus 86 which is like the apparatus 38 shown in FIG. 2. Similar parts as in the apparatus 38 have been given the same reference numerals for ease of comparison and understanding. In the apparatus 86 shown in FIG. 4, the right eye image path 88 is through the reflective surfaces 80, 82 vertically, and then horizontally through reflective surfaces 96, 98. The left eye image path 110 is direct and is shown by a broken line.

Referring now to FIGS. 5 and 6, there is shown image manipulation within endoscope apparatus 88 which comprises a housing 90 which is shown in exploded form for ease of understanding. The housing 90 contains four reflective surfaces 22, 20, 26, 24 which direct light along three mutually perpendicular axes. The reflective surfaces 22, 26 are both mounted with their reflecting surfaces angled downwardly. The reflective surfaces 20, 24 are both mounted with their full reflecting surfaces angled upwardly. The four reflective surfaces 22, 20, 26, 24 have one edge 102, 100, 104, 106 within a flat common plane. The flat common plane passes through a division 108 between the pair of landscape stereoscopic images. In the endoscope apparatus 88, the four reflective surfaces 22, 20, 26, 24 are preferably prisms. If desired, the four reflective surfaces 22, 20, 26, 24 may be mirrors. FIG. 5 shows at 110, 112 images L and R for a camera chip, from the reflective surfaces 24, 26, 20, 22.

Referring now to FIG. 7, similar parts as in previous Figures have been given the same reference numerals for ease of comparison and understanding.

FIG. 7 shows how the invention may be used where the human interface ports have a similar separation distance to that of human eyes. In FIG. 7 the reflective surfaces are preferably front surface mirrors. The left and right eye views may be composed for parallel viewing, analogous to human eyes aimed at a far distance target, or to converge at a finite distance using either hand, with FIG. 7 illustrating for right hand access.

With an endoscope, the stereoscopic lenses are provided through two sets of specialist relay lenses down a tube to a specific target distance, and a fixed focal length is used appropriate to the camera. The equivalent imaging on the general photographic scale has two additional variables. Many cameras have inbuilt zoom to adjust the focal length, and the depth composition of the scene needs adjustment of the image cross-over distance analogous to the swivel of human eyes.

The apparatus shown in FIG. 7 may be attached to the camera lens, for example by using the lens filter thread. Focus may then be set for infinity, and zoom may be set to exclude all but stereoscopic images content. The top and bottom edges of the two images would then ideally match, but motor driven zoom easily overshoots. Such hindrances may be cleared by hunting with the zoom control, but adjusting the vertical periscope is much quicker and more precise once the zoom is sufficient to exclude all but image content.

Where the apparatus of the present invention is in the form of an endoscope, then the endoscope may include endoscope relay lenses which are provided in a tube. The tube is inserted into a patient or other inaccessible small space. The endoscope relay lenses are typically very close together, for example 3 mm apart. For other applications of the present invention, the endoscope relay lenses are not required for the image manipulation pod (two periscopes with appropriate lenses at each port) to do the same job. For non-miniature applications, the human interface port separation is normally similar to the distance between human eyes.

Thus the double periscope arrangement shown in FIGS. 2 and 3 may be used in products other than endoscopes. With such other products, the optical manipulation of the stereoscopic images is carried out for the same reason but on a larger scale, and is represented as a camera attachment in FIG. 7. The camera attachment may be, for example, such that the camera is on a mobile telephone, or an industrial robot.

The apparatus shown in FIG. 3 on small scale may be compared with the apparatus shown in FIG. 7. In FIG. 7, the illustrated apparatus uses a single positive lens instead of two lenses which are used with an endoscope image manipulation pod and the horizontal periscope is acting for left and right image alternatives, but otherwise the same.

FIG. 5 shows the optical manipulation relating to an endoscope, using small scale lens separation of, for example, 3 mm. FIG. 7 shows the same function applicable to an everyday scale, for example with lens separation being at a normal eye separation distance of, for example, 63 mm.

It is to be appreciated that the embodiments of the invention described above with reference to the accompanying drawings have been given by way of example only and that modifications may be effected. The optical re-orientation means may include polarising filters. A polarising frame may form the photographic interface. Individual components shown in the drawings are not limited to use in their drawings and they may be used in other drawings and in all aspects of the invention. The invention also extends to the individual components mentioned and/or shown above, taken singly or in any combination.

1. Hand grip apparatus for use in steering a roll cage, the hand grip apparatus comprising:
(i) a hand grip; and
(ii) releasable connector means for enabling the hand grip to be attached to and removed from the roll cage,
wherein the hand grip comprises:
(iii) a hand grip portion,
and wherein the releasable connector means comprises:
(iv) first and second connector parts which releasably connect together;
(v) the hand grip portion comprises the first connector part; and
(vi) the second connector part is mounted in use on the roll cage.

2. Hand grip apparatus according to claim 1 in which the first connector part is a male first connector part, and in which the second connector part is a female second connector part.

3. Hand grip apparatus according to claim 2 in which the male first connector part comprises a hook, and in which the female second connector part comprises a socket.

4. Hand grip apparatus according to claim 1 in which the hand grip portion is D-shaped.

5. Hand grip apparatus according to claim 1 in which the hand grip portion comprises:
(i) at least one guide slot in the hand grip portion;
(ii) at least one slide portion which extends into the guide slot;
(iii) the guide slot is curved; and
(iv) the slide portion is retained in the guide slot and is slideable backwards and forwards in the guide slot.

6. Hand grip apparatus according to claim 5 in which the guide slot is part circular.

7. Hand grip apparatus according to claim 5 in which the guide slot is in excess of one half of a circle.

8. Hand grip apparatus according to claim 5 which the slide portion comprises a curved formation which has a curve which is complementary to the curve of the guide slot.

9. Hand grip apparatus according to claim 5 in which there is one of the guide slots.

10. Hand grip apparatus according to claim 9 in which the guide slot has a retainer formation for retaining the slide portion in the guide slot.

11. Hand grip apparatus according to claim 10 in which the retainer formation is a pair of inwardly extending lips.

12. Hand grip apparatus according to claim 5 in which there are two of the guide slots and two of the slide portions, in which there is one of the guide slots on each of opposite sides of the hand grip portion, and in which the slide portions are formed by a C-shaped aperture in one end of the connecting portion.

13. A roll cage comprising hand grip apparatus according to claim 1.

14. A roll cage according to claim 13 in which there are two of the hand grip apparatus.
